(19) United States
(12) Patent Application Publication
(10) Pub. No.: US 2026/0133865 A1
(43) Pub. Date: May 14, 2026

(54) METHOD, APPARATUS, DEVICE, AND STORAGE MEDIUM FOR ALARM PROCESSING

(71) Applicant: Beijing Volcano Engine Technology Co., Ltd., Beijing (CN)

(72) Inventor: Xiaodong YUAN, Beijing (CN)

(21) Appl. No.: 19/340,635

(22) Filed: Sep. 25, 2025

(30) Foreign Application Priority Data
Nov. 8, 2024 (CN) 202411598049.1

(51) Int. Cl. G06F 11/07; G06F 11/32; G06F 40/295

(52) U.S. Cl. CPC G06F 11/0769; G06F 11/32; G06F 40/295

(57) ABSTRACT

According to embodiments of the disclosure, a method, an apparatus, a device, and a storage medium for alarm processing are provided. A method includes: determining a first entity involved in a target alarm occurring in a target system based on description information for the target alarm; obtaining first log information related to the first entity and first auxiliary information corresponding to the first log information in the target system, the first auxiliary information describing an abnormality in a log of the target system; and generating an analysis result for the target alarm based on the first log information and the first auxiliary information.

### CROSS-REFERENCE

The present application claims priority to Chinese Patent Application No. 202411598049.1, filed on Nov. 8, 2024, and entitled “METHOD, APPARATUS, DEVICE AND STORAGE MEDIUM FOR ALARM PROCESSING”, which is incorporated herein by reference in its entirety.

### FIELD

Example embodiments of the present disclosure generally relate to the field of computers, and in particular, to a method, an apparatus, a device, and a computer-readable storage medium for alarm processing.

### BACKGROUND

In operation and maintenance management of an information system such as a service network or a service platform, alarm is the most important part in determining whether the information system has a security risk or an intrusion behavior. In particular, in some scenarios, various assets (for example, physical devices, software systems, and applications) in the information system may come from different providers. One such example scenario is a multi-cloud security management scenario. In these scenarios, operation and maintenance personnel need to discover and solve problems in a timely manner through alarms, to ensure availability and stability of the service. However, due to a large number of assets in the information system, the number of alarms has also increased sharply. On the other hand, assets from different providers are not unified in terms of alarm log format, content, and the like. These factors pose great challenges to operation and maintenance personnel. For example, if there is no good monitoring management for scattered alarms for indicators, links, and logs, it is easy to generate an alarm storm. Therefore, an effective management manner is expected for a large number of alarms.

### SUMMARY

In a first aspect of the present disclosure, a method for alarm processing is provided. The method includes: determining a first entity involved in a target alarm occurring in a target system based on description information for the target alarm; obtaining first log information related to the first entity and first auxiliary information corresponding to the first log information in the target system, the first auxiliary information describing an abnormality in a log of the target system; and generating an analysis result for the target alarm based on the first log information and the first auxiliary information.

In a second aspect of the present disclosure, an apparatus for alarm processing is provided. The apparatus includes: an entity determination module configured to determine a first entity involved in a target alarm occurring in a target system based on description information for the target alarm; an information obtaining module configured to obtain first log information related to the first entity and first auxiliary information corresponding to the first log information in the target system, the first auxiliary information describing an abnormality in a log of the target system; and an analysis result generation module configured to generate an analysis result for the target alarm based on the first log information and the first auxiliary information.

In a third aspect of the present disclosure, an electronic device is provided. The device includes at least one processor; and at least one memory, where the at least one memory is coupled to the at least one processor, and stores instructions executable by the at least one processor, and the instructions, when executed by the at least one processor, cause the device to perform the method of the first aspect.

In a fourth aspect of the present disclosure, a computer-readable storage medium is provided. The computer-readable storage medium stores a computer program executable by a processor to implement the method of the first aspect.

It should be understood that content described in this summary section is neither intended to identify key or essential features of embodiments of the present disclosure, nor is intended to limit the scope of the present disclosure. Other features of the present disclosure will be readily envisaged through the following description.

### BRIEF DESCRIPTION OF THE DRAWINGS

The above and other features, advantages, and aspects of embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which embodiments of the present disclosure may be implemented;

FIG. 2 illustrates a schematic diagram of an example architecture for alarm processing according to some embodiments of the present disclosure;

FIG. 3 illustrates a schematic diagram of an example architecture of a mapping relationship between an entity and a data source according to some embodiments of the present disclosure;

FIG. 4 illustrates a schematic diagram of an example interface for parameter configuration according to some embodiments of the present disclosure;

FIG. 5 illustrates a schematic diagram of an example architecture for alarm tracing according to some embodiments of the present disclosure;

FIG. 6 illustrates a flowchart of a process of alarm processing according to some embodiments of the present disclosure;

FIG. 7 illustrates a block diagram of an apparatus for alarm processing according to some embodiments of the present disclosure; and

FIG. 8 is a block diagram of a device capable of implementing a plurality of embodiments of the present disclosure.

### DETAILED DESCRIPTION

It may be understood that before using the technical solutions disclosed in the embodiments of the present disclosure, it is necessary to inform the user of the type, range of use, use scenarios, etc., of personal information involved in the present disclosure in an appropriate manner and obtain the authorization of the user in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

It may be understood that the data involved in the technical solution (including but not limited to the data itself, acquisition or use of the data) should comply with requirements of corresponding laws, regulations, and related provisions.

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any section/subsection provided herein are not restrictive. Various embodiments are described throughout this article, and any type of embodiment may be included under any section/subsection. Furthermore, the embodiments described in any section/subsection may be combined with any other embodiments described in the same section/subsection and/or different section/subsection in any manner.

As used herein, unless explicitly stated, performing a step “in response to A” does not mean that the step is performed immediately after “A”, but may include one or more intermediate steps.

In the description of the embodiments of the present disclosure, the term “include/comprise” and similar terms should be understood as open-ended inclusions, that is, “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other definitions, either explicit or implicit, may be included below. The terms “first”, “second”, and the like may refer to different or same objects. Other definitions, either explicit or implicit, may be included below.

As used herein, the term “model” may learn an association between a corresponding input and output from training data, so that a corresponding output may be generated for a given input after the training is completed. The generation of the model may be based on a machine learning technique. Deep learning is a machine learning algorithm that uses multiple layers of processing units to process the input and provide the corresponding output. As used herein, a “model” may also be referred to as a “machine learning model”, a “machine learning network”, or a “network”, which are used interchangeably herein. A model may include different types of processing units or networks.

As used herein, the judgment of the alarm refers to determining whether the alarm actually has a risk or a probability of having a risk. The tracing of the alarm refers to determining a source, an attack link, and the like of an event corresponding to the alarm.

As briefly mentioned above, with the continuous expansion of services and the continuous upgrade of systems, the number of alarms has also increased sharply. Conventionally, the management of alarms is mainly performed by providing original log search. However, this method has a weak capability in terms of alarm event judgment and tracing, and the original logs need to be understood manually, which increases the cost.

Further, the capability of event judgment and tracing may be improved by adding a large amount of expert experience and a large amount of context data mining. However, a large investment is required for the construction to improve the capability of event judgment and tracing. Correspondingly, the investment of various technologies and a large amount of expert experience is required, for example, extraction of entity relationships, recommendation experience of a large number of experts (for example, log search), investigation graphs, and the like.

In view of this, embodiments of the present disclosure provide a solution for alarm processing. According to various embodiments of the present disclosure, a first entity involved in a target alarm occurring in a target system is determined based on description information for the target alarm. Subsequently, first log information related to the first entity and first auxiliary information corresponding to the first log information are obtained from the target system. The first auxiliary information is used to describe an abnormality in a log of the target system. Then, an analysis result for the target alarm is generated based on the first log information and the first auxiliary information.

In embodiments of the present disclosure, for a generated alarm, an entity involved in the alarm is first extracted, that is, the focus is first placed on the entity that may have a potential problem. Then, the focus is further placed on log information and auxiliary information related to the entity. In this way, information related to a current alarm event may be extracted from a large amount of data in the target system, and such information may be used to analyze the alarm. In this way, manual viewing of a log system by operation and maintenance personnel may be reduced, the management cost for the alarm may be reduced, and the efficiency of processing the alarm may be improved.

### Example Environment

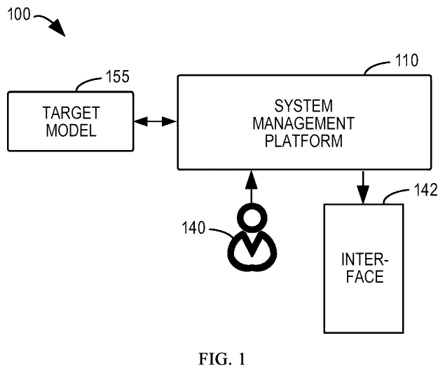

FIG. 1 illustrates a schematic diagram of an example environment 100 in which the embodiments of the present disclosure may be implemented. As shown in FIG. 1, the environment 100 may include a system management platform 110. In the example environment 100, the system management platform 110 may be configured to manage a large number of alarms generated by hosts, networks, security devices, and the like that are included in an organization (an enterprise, a government agency, another group, or the like). The system management platform 110 may present the large number of alarms in a list in an interface 142 corresponding to the system management platform 110. A user 140 may manage the large number of alarms in the organization based on the system management platform 110.

The system management platform 110 determines, based on description information of an alarm that occurs in the organization, log information of an entity corresponding to the alarm and auxiliary information used to describe an abnormality in the log. Then, the system management platform 110 generates an analysis result of the alarm based on the log information and the auxiliary information. In some embodiments, the implementation of at least some functions of the system management platform 110 may be implemented based on a target model 155.

The system management platform 110 may call one or more target models 155, for example, a capability of the target model 155, in a process of generating the analysis result for the alarm that occurs in the organization. As used herein, the term “model” may learn an association between a corresponding input and output from training data, so that a corresponding output may be generated for a given input after the training is completed. The generation of the model may be based on a machine learning technique. Deep learning is a machine learning algorithm that uses multiple layers of processing units to process the input and provide the corresponding output. A neural network model is an example of a model based on deep learning. As used herein, a “model” may also be referred to as a “machine learning model”, a “learning model”, a “machine learning network”, or a “learning network”, which are used interchangeably herein.

The system management platform 110 may be deployed locally on a terminal device of the user 140, and/or may be supported by a server device. For example, the terminal device of the user 140 may run a client of the system management platform, and the client may support interaction between the user and the system management platform provided by the server. In the case where the system management platform runs locally on the terminal device of the user, the user 140 may directly use the terminal device to interact with the local system management platform. In the case where the system management platform runs on the server device, the server device may implement service provision for the client running on the terminal device based on a communication connection with the terminal device. The system management platform 110 may present a corresponding interface 142 to the user 140 based on an operation of the user 140, to output information related to system management to the user 140 and/or receive the information related to system management from the user 140.

The system management platform 110 may run on a suitable electronic device. The electronic device herein may be any type of device having a computing capability, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including fittings and peripherals of these devices or any combination thereof. The server device may include, for example, a computing system/server, such as a mainframe, an edge computing node, a computing device in a cloud environment, and the like. In some embodiments, the data management platform 110 may be implemented based on a cloud service.

It should be understood that the structure and functions of the environment 100 are described for illustrative purposes only, and are not intended to limit the scope of the present disclosure.

Some example embodiments of the present disclosure are described below with continued reference to the drawings. Hereinafter, the example embodiments are mainly described with reference to the system management platform 110. It should be understood that the actions described with reference to the system management platform 110 may be performed by a plugin included in the system management platform 110, or may be performed by the plugin in cooperation with its server (for example, a server) and/or a machine learning model.

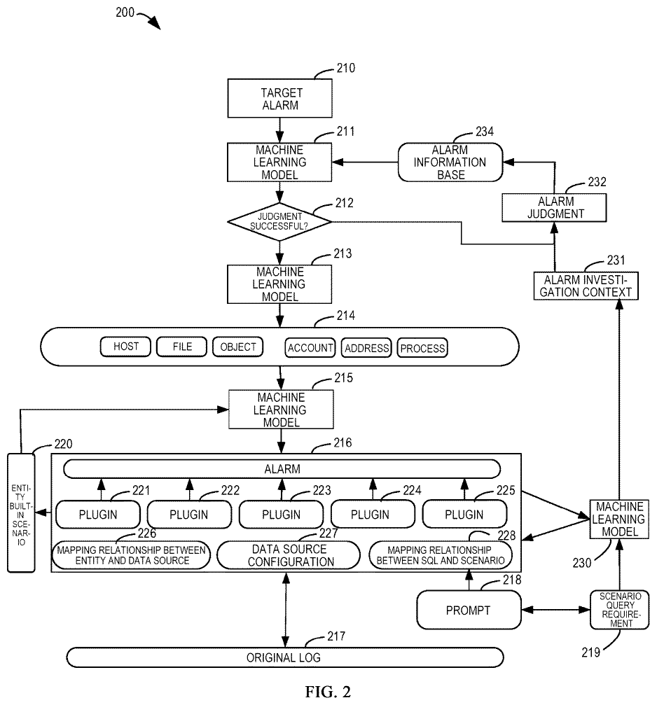

The process for alarm processing according to the present disclosure is first described below with reference to FIG. 2. FIG. 2 illustrates a schematic diagram of an example architecture 200 for alarm processing according to some embodiments of the present disclosure.

In some embodiments, the system management platform 110 determines a first entity involved in a target alarm occurring in a target system based on description information for the target alarm. In some examples, the description information of the target alarm (for example, detailed information of the target alarm) may include one or more of: a name of the target alarm, an occurrence time of the target alarm, a context field related to the target alarm, an original log corresponding to the target alarm, a device corresponding to the target alarm, login information, and the like. The specific content of the description information of the target alarm is related to the type of the target alarm.

In some examples, the system management platform 110 may generate the first entity related to the target alarm based on the description information of the target alarm. In the description herein, the entity may refer to various types of components, for example, physical components and abstract components, that may be distinguished and recognized in an information system. In some embodiments, the first entity includes at least one of a host, a file, an object, an account, an address, and a process. In some examples, the first entity may be an entity determined from a plurality of predetermined types of entities. For example, the entities involved in the target alarm include an IP address, a host, a process, an account, an object, a file, and the like. In an example process 200 shown in FIG. 2, the system management platform 110 obtains the description information of the target alarm at block 210. At block 211, the system management platform 110 may input the description information of the target alarm into a machine learning model 211. At block 212, the system management platform 110 determines, based on the description information of the target alarm, whether there is an alarm matching the target alarm in an alarm information base via the machine learning model 211. In some embodiments, the alarm information base is obtained based on judgment on historical alarms, which includes description information and analysis results corresponding to each historical alarm.

In the case where there is no alarm matching the target alarm in the alarm information base, the system management platform 110 determines the first entity involved in the target alarm based on the description information of the target alarm. How the system management platform 110 determines the first entity involved in the target alarm in the case where there is an alarm matching the target alarm in the alarm information base is described below with continued reference to FIG. 2. At block 213, in the case where there is no alarm matching the target alarm in the alarm information base, the system management platform 110 may input the description information of the target alarm into the machine learning model. At block 214, the system management platform 110 obtains a plurality of entities (for example, an address, a domain name, a file, a resource, an account, a user, and an alarm) related to the target alarm that are output by the machine learning model, where the plurality of entities include the first entity.

In some examples, the system management platform 110 extracts an entity related to the target alarm according to the description information of the target alarm. For example, in the case where there is an external connection of an asset to an external IP or the external IP accesses the asset in the log details, the system management platform 110 extracts an IP entity. If an alarm entity is extracted, an alarm name, an earliest alarm sending time, and a latest alarm update time are extracted, and all of them are represented by time stamps. If the asset in the log details belongs to a cloud account, a user entity is extracted. If the user entity is extracted, a cloud account to which the current asset belongs, a name of the cloud account to which the current asset belongs, and the like are extracted. If the asset in the alarm details is a host, a host entity is extracted, which includes an ID of the host asset, a name of the host asset, a private network IP of the host asset, and a public network IP of the host asset.

If there is a domain name asset of a Web application firewall (WAF) alarm or a domain name matched from a command line parsing library (cmdline), a domain name entity is extracted. If there is a file (for example, a malicious file or a downloaded file) in the alarm details, a file entity is extracted, including a file path, a hash value of the file, or an information digest algorithm (md5) value of the file. If there is process-related information in the alarm details, a process entity is extracted, including a process ID, a process name, a file that starts the process, a process start time, a host ID that starts the process, a user ID that executes the process, a command that starts the process, a process call chain, an ID of a parent process, a name of the parent process, and a command that starts the parent process. If a cloud resource interface is accessed, the interface is abstracted into a service entity, which includes a service name, a service ID, and a method or operation of the service.

In some embodiments, the system management platform 110 obtains first log information related to the first entity and first auxiliary information corresponding to the first log information in the target system. In some embodiments, the first auxiliary information is used to describe an abnormality in a log of the target system. The auxiliary information corresponding to the log information may be, for example, a predetermined rule, an expert description, or the like.

In some examples, the system management platform 110 obtains a plurality of data sets associated with the first entity after determining the first entity involved in the target alarm. Each of the plurality of data sets includes first log information (for example, a login log, a network log, or the like) related to the first entity and first auxiliary information (which may also be referred to as a judgment rule or a prompt for providing to a machine learning model) corresponding to the first log information. For example, for the IP entity, a login log corresponding to the IP address and first auxiliary information that corresponds to the login log and that is used to indicate an abnormality (for example, an abnormal behavior such as brute force cracking or access to a sensitive interface) may be obtained. For the host entity, a network log of the host and first auxiliary information that corresponds to the network log and that is used to indicate an abnormality may be obtained. The system management platform 110 obtaining the first log information related to the first entity and the first auxiliary information corresponding to the first log information is described in detail below.

In some embodiments, the system management platform 110 generates the analysis result for the target alarm according to the first log information and the first auxiliary information. In some examples, the system management platform 110 generates context of the target alarm based on the first log information and the first auxiliary information, and summarizes a plurality of pieces of context into an analysis report for the target alarm. In some examples, the system management platform 110 may obtain the analysis result output by the machine learning model in a predetermined format (for example, a JSON format).

For example, the analysis result for the target alarm generated by the system management platform 110 may include an attack rate corresponding to the target alarm, an attack rate corresponding to the first entity, logic for analyzing the target alarm, detailed information about an abnormality in each entity involved in the target alarm, and the like. In some examples, the system management platform 110 may use the machine learning model to generate the context of the target alarm according to the first log information and the first auxiliary information.

Continuing with the process 200, because the original log 217 includes log fragments in various storage systems, the system management platform 110 may obtain these log fragments based on the plugin. In some examples, the system management platform 110 may obtain, for each log fragment, a prompt 218 (which may also be referred to as expert experience or a rule) configured by the user based on a scenario query requirement 219.

At block 230, the system management platform 110 obtains the analysis result for the first entity by calling the machine learning model based on the log fragment of the first entity (for example, the domain name entity) and the prompt 218 corresponding to the log fragment. For example, the first entity may correspond to a plurality of data sets, and each data set may correspond to a plurality of rules. In some examples, the system management platform 110 may call the machine learning model to obtain an attack probability corresponding to each data set. Correspondingly, the attack probability of the first entity may be calculated using the following expression: 1−(1−an attack rate of a data set)*(1−an attack rate of b data set)* . . . *(1−an attack rate of n data set). In some examples, if the attack probability of an entity is greater than a predetermined probability threshold (for example, XX %), the entity has a risk of attack.

At block 231, the system management platform 110 determines the analysis result of the target alarm (that is, a report formed by the contextual information of the target alarm) based on analysis results respectively corresponding to the plurality of entities that are obtained by calling the machine learning model. Subsequently, the system management platform 110 may store the description information and the analysis result of the target alarm in an alarm information base 234.

In this way, processing the alarm based on the log information and the auxiliary information may reduce a threshold for alarm judgment and tracing, thereby improving the efficiency of alarm processing. The system management platform 110 obtaining the first log information related to the first entity and the first auxiliary information corresponding to the first log information is described below.

In some embodiments, the system management platform 110 determines at least one scenario based on an entity type of the first entity. In some embodiments, the scenario in the at least one scenario is configured with a corresponding log range and an abnormal state description within the log range. In some embodiments, the system management platform 110 first determines a plurality of candidate scenarios corresponding to the first entity type. Then, the system management platform 110 uses the machine learning model to select the at least one scenario from the plurality of candidate scenarios according to the description information of the target alarm.

Continuing with the process 200, at block 215, the system management platform 110 inputs the first entity in the plurality of entities 214 into the machine learning model. At block 216, the system management platform 110 calls a plugin (for example, a search plugin) 221, a plugin (for example, a log service language plugin) 222, a plugin (for example, a visualization plugin) 223, a plugin (for example, a transport layer plugin) 224, a plugin (for example, another log query plugin) 225, and another plugin to obtain a plurality of candidate scenarios (which may also be referred to as built-in entity scenarios) 220 for the first entity. It may be understood that the system management platform 110 uses the plugin to convert the data set corresponding to the first entity into a natural language that may be understood by the machine learning model. Then, the system management platform 110 uses the machine learning model to determine, from the plurality of candidate scenarios, the at least one scenario for investigating whether the target alarm is abnormal.

In some embodiments, the at least one scenario is configured with a corresponding log range and an abnormal state description within the log range. It may be understood that the at least one scenario indicates a plurality of rules (for example, prompts for providing to the machine learning model) corresponding to the data set related to the first entity associated with the target alarm. The data set and the scenario are in a one-to-many relationship, that is, one data set may be configured with a plurality of rules (for example, prompts for providing to the machine learning model). As shown in Table 1, the user may customize and expand the prompt based on the data set. Table 1 is an example of the at least one scenario.

TABLE 1

| Entity | Data source | Data set name | Prompt |
|---|---|---|---|
| IP | Intelligence | Match input IP | Intelligence matching: analyze, based on |
| | | | intelligence content, whether the IP is a |
| | | | malicious IP. If the intelligence is marked as a |
| | | | malicious IP, this alarm is determined as an |
| | | | attack, and an analysis report is given based |
| | | | on intelligence context |
| | Login log | Login log in N days | When an input cloud audit log is received, |
| | | before the alarm | analysis is performed according to the |
| | | | following steps, and a corresponding score is |
| | | | increased based on the severity of the risk. |
| | | | Output must be performed strictly in a |
| | | | specified format: |
| | | | 1. Generate a json, where a key is a character |
| | | | string ‘Host’, and a value is a json array for |
| | | | storing temporary data. The structure of an |
| | | | element of the array is as follows: |
| | | | hostId |
| | | | reason |
| | | | 1. If there is a brute force cracking operation |
| | | | or a large number of login failure operations, |
| | | | it indicates that a hacker is trying to attack. In |
| | | | addition, extract the following fields and place |
| | | | the fields in the json array with the key ‘Host’ |
| | | | (all fields that meet the conditions must be |
| | | | output): |
| | | | hostId: host ID |
| | | | reason: ‘suspicious #{ip} attempts brute force |
| | | | cracking’ |
| | Audit log | Audit log in N days | Background: service name related to login: |
| | | after the alarm | NameLogin, interface name: signin |
| | | | When an input cloud audit log is received, |
| | | | analysis is performed according to the |
| | | | following steps, and a corresponding score is |
| | | | increased based on the severity of the risk. |
| | | | Output must be performed strictly in a |
| | | | specified format: |
| | | | 1. Generate a json, where a key is a character |
| | | | string ‘User’, and a value is a json array for |
| | | | storing temporary data. The structure of an |
| | | | element of the array is as follows: |
| | | | cloudUserId |
| | | | reason |
| | | | ak, specific ak |
| | | | service: service name |
| | | | action: interface method |
| | | | 2. Call an intelligence plugin ‘tiForIp’ for a |
| | | | suspicious IP, use the suspicious IP as input, |
| | | | and determine whether the IP is malicious |
| | | | based on an intelligence return value. If the IP |
| | | | is malicious intelligence, directly determine |
| | | | that this is an attack. |
| | Host network log | Network external | According to the host network log, analyze |
| | | connection log in N | how many assets are externally connected to |
| | | days after the alarm | this IP in 7 days before and after the alarm. If |
| | | | the IP is malicious, it indicates that a plurality |
| | | | of assets have been compromised |
| | Host network log | Accessed log in N | According to the host network log, analyze |
| | | days after the alarm | how many assets are accessed by this IP in 7 |
| | | | days before and after the alarm. If the IP is |
| | | | malicious, it indicates that a plurality of assets |
| | | | have been compromised |
| Process | Process log | Host process log in N | Log description: The current log is a process |
| | | days before and after | creation log of the current host in 12 hours. |
| | | the alarm | Please perform the following analysis: |
| | | | 1. List a call chain of the process according to |
| | | | a time axis based on process information of |
| | | | the current alarm. |
| | | | 2. If there is a suspicious IP external |
| | | | connection or accessed by a suspicious IP in a |
| | | | cmdline of the process, concatenate all |
| | | | suspicious IPs with a comma, call the |
| | | | intelligence plugin ‘tiForIp’ with the |
| | | | concatenated string as a parameter, and |
| | | | determine, based on a return result, whether |
| | | | there is a suspicious abnormal behavior. |
| | | | 3. Determine whether the current process has |
| | | | an abnormal behavior, for example, external |
| | | | connection, privilege escalation, command |
| | | | execution, creation of a scheduled task, or |
| | | | reverse shell. |
| | Process log | Host process log in N | Log description: The current log is a process |
| | | days before and after | creation log of the current host in 12 hours. |
| | | the alarm | Please perform the following analysis: |
| | | | 1. List a call chain of the process according to |
| | | | a time axis based on process information of |
| | | | the current alarm. |
| | | | 2. If there is a suspicious IP external |
| | | | connection or accessed by a suspicious IP in a |
| | | | cmdline of the process, concatenate all |
| | | | suspicious IPs with a comma, call the |
| | | | intelligence plugin ‘tiForIp’ with the |
| | | | concatenated string as a parameter, and |
| | | | determine, based on a return result, whether |
| | | | there is a suspicious abnormal behavior. |
| | | | 3. Determine whether the current process has an |
| | | | abnormal behavior, for example, external |
| | | | connection, privilege escalation, command |
| | | | execution, creation of a scheduled task, or |
| | | | reverse shell. |

In some embodiments, the system management platform 110 determines the first log information based on the log range respectively configured in the at least one scenario. As shown in Table 1, each row represents one scenario. The log range configured in the scenario, for example, a login log in first N days before the alarm, is shown in the second row in Table 1. Subsequently, the system management platform 110 may determine the first log information that needs to be extracted based on the login log in the first N days before the alarm and the occurrence time of the alarm.

In some embodiments, the system management platform 110 extracts, from the target system based on a log range configured in a first scenario in the at least one scenario, a target log fragment as at least a part of the first log information. In some examples, the system management platform 110 may extract the target log fragment from the target system based on the log range configured in the first scenario and by using a log query statement of the data set corresponding to the first entity. In some examples, each data set corresponds to one query statement (for example, a structured query statement SQL). Due to differences in log formats of different users, there are differences in SQL statements. Therefore, mapping between an SQL template field and an original log field may be automatically completed through a prompt for generating the SQL statement. As shown in Table 2, the data set may be expanded. Table 2 shows a plurality of examples of the data set.

TABLE 2

| | Data | Dataset | | Prompt for generating SQL |
|---|---|---|---|---|
| Entity | source | name | DataSet query statement | statement |
| IP | Intelligence | Intelligence | select * from #{ti} | |
| | | report | | |
| | Login log | Login log | #{occure_time}># {before_N_alert_time} and # | According to the sample |
| | | in N days | {occure_time}<=#{alert_time} and # | log, help me map the fields |
| | | before the | {source_ip}=#{alert.ip} | according to the following |
| | | alarm | | rules: |
| | | | | occure_time: the field |
| | | | | name of the login time in |
| | | | | the sample |
| | | | | source_ip: the field name |
| | | | | of the IP of the login user |
| | | | | in the sample |
| | Audit log | Audit log | #{occure_time}>=#{alert_time}and# | According to the sample |
| | | in N days | {occure_time}<#{after_N_alert_time} | log, help me map the fields |
| | | after the | and#{source_ip}:#{ip} | according to the following |
| | | alarm | | rules: |
| | | | | occure_time: the field |
| | | | | name of the request |
| | | | | occurrence time in the |
| | | | | sample |
| | | | | source_ip: the field name |
| | | | | of the IP that calls the |
| | | | | interface in the sample |
| | Host | Network | #{occure_time}>=#{alert_time}and# | According to the sample |
| | network | external | {occure_time}<#{after_N_alert_time} | log, help me map the fields |
| | log | connection | and#{dst_ip=:#{alert.ip}and# {deriction}=#‘{out}’ | according to the following |
| | | log in N | | rules: |
| | | days after | | occure_time: the field |
| | | the alarm | | name of the request |
| | | | | occurrence time in the |
| | | | | sample |
| | | | | dst_ip: the field name of |
| | | | | the target IP in the sample |
| | | | | deriction: the field name of |
| | | | | the access direction in the |
| | | | | sample |
| | | | | out: the field value |
| | | | | representing the egress |
| | | | | direction in the sample |
| Process | Process log | Host | #{occure_time}># {before_N_alert_time}and# | According to the sample |
| | | process log | {occure_time}<=#{after_N_alert_time} | log, help me map the fields |
| | | in N days | and#{asset_id}:#{asset.id} | according to the following |
| | | before and | | rules: |
| | | after the | | occure_time: the field |
| | | alarm | | name of the request |
| | | | | occurrence time in the |
| | | | | sample |
| | | | | asset_id: the field name of |
| | | | | the ID of the asset in the |
| | | | | sample |
| | Process log | Host | #{occure_time}># {before_N_alert_time}and# | According to the sample |
| | | process log | {occure_time}<=#{alert_time}and# | log, help me map the fields |
| | | in N days | {asset_id}:#{asset.id} | according to the following |
| | | before and | | rules: |
| | | after the | | occure_time: the field |
| | | alarm | | name of the request |
| | | | | occurrence time in the |
| | | | | sample |
| | | | | asset_id: the field name of |
| | | | | the ID of the asset in the |
| | | | | sample |

In some embodiments, the log range configured in the first scenario indicates a log name and a time range. In some embodiments, the system management platform 110 determines a target log in the target system based on the log name. Correspondingly, the system management platform 110 determines an extraction range of the target log based on the occurrence time of the alarm and the time range. Then, the system management platform 110 extracts, from the target log, a part within the extraction range as the target log fragment.

As shown in Table 1, the log range configured in the scenario is shown in the second row in Table 1. For example, the log name is the login log, and the time range is the first N days. The system management platform 110 may determine the extraction range of the target log that needs to be extracted according to the log whose log name is the login log and the occurrence time of the alarm. Then, the system management platform 110 extracts, from the target log, a part that has a risk as the target log fragment. It may be understood that the data set related to the entity type of the first entity is determined, and the data set indicates the log fragment of the core field of the first entity.

In some embodiments, the system management platform 110 determines the first auxiliary information based on the abnormal state description configured in the first scenario. In some embodiments, the system management platform 110 determines, according to the abnormal state description configured in the first scenario, a first auxiliary information item corresponding to the target log fragment, to describe an abnormality in the target log fragment. In some examples, one entity may correspond to a plurality of scenarios, and each scenario has a corresponding prompt, that is, an auxiliary information item, for providing to the machine learning model. Therefore, the auxiliary information is a collection of a plurality of auxiliary information items. That is, the system management platform 110 determines the first auxiliary information item corresponding to the target log fragment based on the prompt configured in the first scenario.

Continuing with the process 200, the system management platform 110 determines the first log information from the original log 217 based on the mapping relationship between the plugin, the entity, and the data source, the data source configuration, and the mapping relationship between the SQL and the scenario.

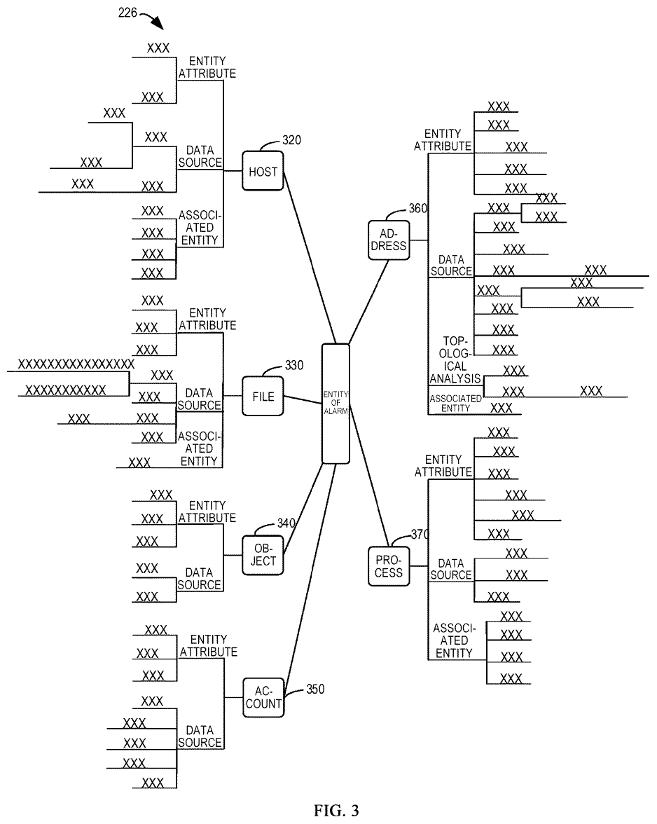

The mapping relationship 226 between the data source and the entity is described below with reference to FIG. 3 for ease of understanding. FIG. 3 is a schematic diagram of an example architecture of a mapping relationship between an entity and a data source according to some embodiments of the present disclosure.

As shown in FIG. 3, the mapping relationship between the host entity 320 related to the target alarm and the data source may include, for example, an alarm and a risk, the alarm includes intrusion backtracking and lateral analysis, and the risk includes a highly exploitable risk. The mapping relationship between the file entity 320 related to the target alarm and the data source may include, for example, file downloading, file change, host fingerprint, and alarm. The mapping relationship between the object entity 340 related to the target alarm and the data source may include, for example, an audit log and a level certificate. The mapping relationship between the account entity 350 related to the target alarm and the data source may include, for example, a login log, a file change log, a host network log, a host process log, and an alarm. The mapping relationship between the address entity 360 related to the target alarm and the data source may include, for example, an alarm, a host network, network address translation, process outreach, download analysis, a login log, an audit log, and a domain name system. The mapping relationship between the process entity 370 related to the target alarm and the data source may include, for example, host process startup, host network connection, and alarm.

In some embodiments, the system management platform 110 performs associated entity detection for the first entity based on the first log information and the first auxiliary information. If the system management platform 110 detects a second entity associated with the first entity, the system management platform 110 obtains second log information related to the second entity and second auxiliary information corresponding to the second log information in the target system, the second auxiliary information being used to describe an abnormality in the log of the target system. Correspondingly, the system management platform 110 performs associated entity detection for the second entity based on the second log information and the second auxiliary information. Then, the system management platform 110 determines an occurrence path of the target alarm based on the first entity and a result of the associated entity detection for the second entity.

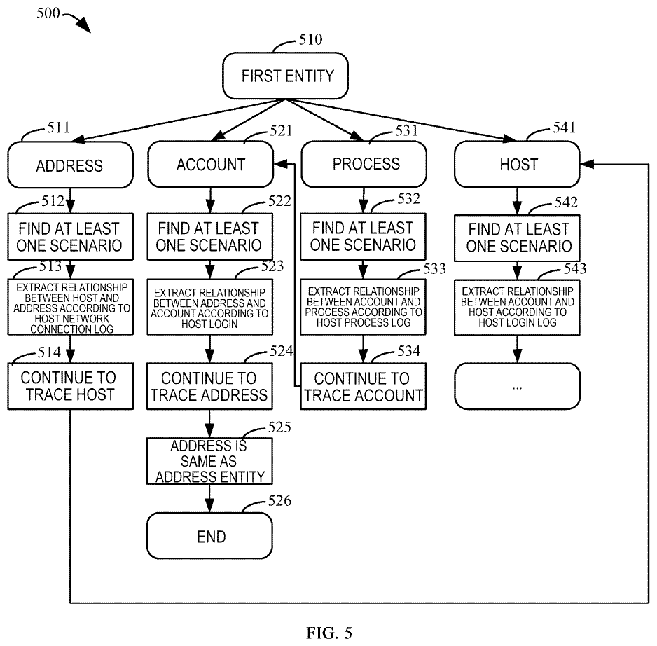

FIG. 5 illustrates a schematic diagram of an example process 500 for alarm tracing according to some embodiments of the present disclosure. As shown in FIG. 5, the system management platform 110 may trace the first entity 510 based on the first log information and the first auxiliary information. That is, at block 512, if the system management platform 110 detects the address entity 511 related to the first entity 510, the system management platform 110 may determine at least one scenario based on an entity type of the address entity 511. At block 513, the system management platform 110 may extract, based on the at least one scenario corresponding to the address entity 511, a relationship between the host entity 541 and the address entity 511 based on log information (for example, a host network connection log) corresponding to the address entity 511. At block 514, the system management platform 110 may trace back to the host entity 541 based on the relationship between the host entity 541 and the address entity 511.

At block 542, the system management platform 110 may determine at least one scenario based on an entity type of the host entity 541. At block 543, the system management platform 110 may extract, based on the at least one scenario corresponding to the host entity 541, a relationship between the account entity 521 and the host entity 541 based on log information (for example, a host login log) corresponding to the host entity 541. In some examples, the system management platform 110 may trace back to the account entity 521 based on the relationship between the host entity 541 and the account entity 521.

Correspondingly, at block 532, if the system management platform 110 detects the process entity 531 related to the first entity 510, the system management platform 110 may determine at least one scenario based on an entity type of the process entity 531. At block 533, the system management platform 110 may extract, based on the at least one scenario corresponding to the process entity 531, a relationship between the account entity 521 and the process entity 533 based on log information (for example, a host process log) corresponding to the process entity 531. At block 534, the system management platform 110 may trace back to the account entity 521 based on the relationship between the account entity 521 and the process entity 533.

At block 522, the system management platform 110 may determine at least one scenario based on an entity type of the account entity 521. At block 523, the system management platform 110 may extract, based on the at least one scenario corresponding to the account entity 521, a relationship between the account entity 521 and the address entity 511 based on log information (for example, a host login log) corresponding to the account entity 521. At block 524, the system management platform 110 may trace back to the address entity 511 based on the relationship between the account entity 521 and the address entity 511. At block 525, the system management platform 110 determines whether the account entity 521 and the address entity 511 are the same. At block 526, if the system management platform 110 determines that the account entity 521 and the address entity 511 are the same, the system management platform 110 ends tracing of the address entity 511.

In this way, the source of the risk of the entity may be determined by tracing the entity with the risk. How the system management platform 110 determines the first entity involved in the target alarm in the case where there is an alarm matching the target alarm in the alarm information base is described below with continued reference to FIG. 2.

In some embodiments, the system management platform 110 obtains an alarm information base including respective description information and respective analysis results of a plurality of historical alarms that occur in the target system. In some examples, the system management platform 110 may obtain the alarm information base including the analysis results of the historical alarms generated by the system management platform 110 based on corresponding log information and auxiliary information of the historical alarms.

In some embodiments, the system management platform 110 updates the alarm information base based on the description information of the target alarm and the analysis result for the target alarm. Referring back to the example process 200 shown in FIG. 2, the system management platform 110 may store, in the alarm information base 234, description information of a current alarm generated for the current alarm and an analysis result corresponding to the description information.

Further, if the system management platform 110 receives the target alarm, the system management platform 110 retrieves, based on the description information of the target alarm, a historical alarm matching the target alarm from the alarm information base. Then, if the system management platform 110 does not retrieve a historical alarm matching the target alarm, the system management platform 110 uses the machine learning model to determine the first entity based on the description information.

Continuing to refer back to the example process 200 shown in FIG. 2, at block 212, the system management platform 110 calls the machine learning model based on the target alarm to determine whether the target alarm is successfully determined. At block 232, the system management platform 110 determines, based on the description information of the target alarm, a historical alarm matching the target alarm from the alarm information base 234. If the system management platform 110 determines, from the alarm information base 234, that there is a historical alarm matching the target alarm, the system management platform 110 returns the analysis result for the target alarm. Correspondingly, if the system management platform 110 determines, from the alarm information base 234, that there is no historical alarm matching the target alarm, the system management platform 110 uses the machine learning model to determine the target alarm.

In this way, storing the analysis result and the description information of the alarm in the alarm information base may provide a basis for determination of a subsequent similar alarm. How the system management platform 110 deploys the machine learning model before obtaining the first log information is described below.

In some embodiments, the system management platform 110 determines, before obtaining the first log information, a target log field corresponding to a variable in a log query instruction in a target log of the target system. In some embodiments, the system management platform 110 extracts a plurality of log records from the target log. Correspondingly, the system management platform 110 provides prompt information to the machine learning model based on a variable description for the variable and the plurality of log records, to obtain an output of the machine learning model. Then, the system management platform 110 determines the target log field based on one or more target fields indicated by the output of the machine learning model.

It may be understood that the system management platform 110 needs to deploy the machine learning model before obtaining the first log information. In some examples, the system management platform 110 provides an application programming interface (API) to call the machine learning model. The system management platform 110 may also provide a world wide web (web) service to provide a plugin capability for the machine learning model. The machine learning model is preconfigured with built-in metadata, for example, the machine learning model is preconfigured with a prompt, a data set, a plugin usage, judgment expert experience, and tracing expert experience.

In some examples, the machine learning model is preconfigured with a plurality of prompts with different functions, for example, a prompt for extracting an entity and a general prompt for executing a data set and expert experience. The machine learning model may be preconfigured with commonly used data sets, and these data sets may be saved in a csv file or a db file. In some examples, the data sets preconfigured in the machine learning model may be expanded as needed. As shown in Table 2, the user may expand the data sets. A table name and a field corresponding to a data set do not depend on a log of the user, and all available data sets may be built in the machine learning model in advance. For a log table configured in the machine learning model, the system management platform 110 may filter out the log table on a client side corresponding to the user. Table 3 illustrates an example of configuration information required by the data sets built in the machine learning model.

TABLE 3

| | | | Description | Start |
|---|---|---|---|---|
| Entity | Log table | Data set name | information | time |
| IP | ssh | login-from-ip | XXXXX | XX |
| IP | ti_for_ip | ti_for_ip | XXXXXX | XX |
| Host | alert | alert-context | XXXXXXXX | XXX |
| Account | process | process-context | XXXXXXXX | XXX |
| User | audit | audit -context | XXXXXXXXXX | XX |
| Host | risk | risk-context | XXXXXXXX | XXXX |

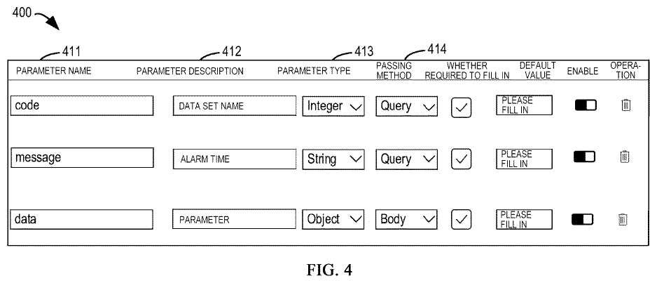

In some examples, the system management platform 110 may configure, in the machine learning model, a parameter corresponding to a plugin that needs to be called by the machine learning model. FIG. 4 is a schematic diagram of an example interface 400 for parameter configuration according to some embodiments of the present disclosure. As shown in FIG. 4, a user (which may also be referred to as a manager) may configure the interface 400 for parameter configuration presented by the system management platform 110 in the interface 142. The user may configure, in the interface 400, a parameter name 411, parameter description information 412, a parameter type 413, a passing method 414 corresponding to the parameter, and the like that correspond to the plugin.

In some examples, the system management platform 110 may integrate different pieces of expert experience based on the data set, and the expert experience may be stored in a csv file or a db file. Correspondingly, the expert experience preconfigured in the machine learning model may also be expanded as needed. Table 4 shows an example of configuration information required by the expert experience.

TABLE 4

| | | Description of | | Description | |
|---|---|---|---|---|---|
| ID | Entity | data set | Data set name | information | Prompt |
| 10 | IP | Intelligence | XXXX | XXXXXXXXX | XXXX |
| 100 | IP | XX | XXXX | XXXXXXX | XXXX |
| 300 | Account | 12 hours before | XXXXX | XXXXXXXXXXXX | XXXXX |
| | | and after the | | | |
| | | alarm | | | |
| 500 | Host | XX of 7 before | XXXXX | XXXXXXXX | XXXXX |
| | | and after the | | | |
| | | alarm | | | |
| 800 | User | XXXX | XXXXXX | XXXXXXXXXX | XXXXX |

For the tracing expert experience, the system management platform 110 may integrate different pieces of expert experience based on the data set. The expert experience may be stored in, for example, a csv file or a db file. Correspondingly, the expert experience preconfigured in the machine learning model may also be expanded as needed. Table 5 shows an example of configuration information required by the tracing expert experience.

TABLE 5

| | | Description of | | Description | |
|---|---|---|---|---|---|
| ID | Entity | data set | Data set name | information | Prompt |
| 1000 | IP | Host external | out-connect | XXXXXXXXX | XXXX |
| | | connection log | | | |
| 2000 | Account | Host login log | login-context | XXXXXXXXXXXX | XXXXX |
| 3000 | Process | Host process | process-context | XXXXXXXX | XXXXX |
| | | log | | | |

In some embodiments, a plurality of entities corresponding to an alarm may be determined based on the alarm, and each of the plurality of entities corresponds to a plurality of data sets. Each of the plurality of data sets may be preconfigured. In some examples, a log type corresponding to the data set and a necessary field mapping that needs to be learned by the large model may be preconfigured. In some examples, in the case where the log type is in a table form, a name of a table corresponding to the log may be different from a table name of the user, but needs to be consistent with the configuration of the data set. In some examples, the log may be stored in a file and tls format. If the log type is in a form of a logical table, a query condition needs to be added to the configuration information. If the log type is in a form of a file, the file needs to be placed in a predetermined directory.

In some examples, the machine learning model needs to learn a necessary field mapping, for example, the machine learning model learns a field mapping configured in the data set. Based on the necessary field mapping, the machine learning model may convert a standard field into its corresponding original field in a scenario of calling the plugin capability. Table 6 illustrates an example of a field mapping table.

TABLE 6

| | | Variable description | |
|---|---|---|---|
| Log | Field | (prompt for generating | Original field |
| name | variable | the SQL statement) | name in the log |
| ssh | hostID | Field name | device.instan ce_id |
| | | corresponding to a host | |
| | | ID. The host ID is a | |
| | | unique identification | |
| | | host. Note the distinction | |
| | | from a host name. | |
| ssh | srclp | Field name | src_endpoint .ip |
| | | corresponding to a | |
| | | source IP address that | |
| | | logs in to the | |
| | | host in the log | |
| host- | dstlp | Field name | dip |
| net- | | corresponding to | |
| activity | | a destination IP | |
| | | address in the log | |
| audit | ak | In an interface call, it | unmapped.AccessKeyID |
| | | represents a field name | |
| | | of an ak credential for | |
| | | accessing the interface | |
| alert | hostID | Field name | umapped.ag ent_id |
| | | corresponding to a host | |
| | | ID. The host ID is a | |
| | | unique identification | |
| | | host. Note the distinction | |
| | | from a host name. | |
| process | accountID | accountId: account | |
| | | ID that starts a | |
| | | process, which is usually | |
| | | expressed as uid in an | |
| | | operating system, for | |
| | | example, uid = 0 | |

In some embodiments, the system management platform 110 may enable the machine learning model to learn the field mapping in the following manner. The system management platform 110 extracts a configuration in the data set configuration, and generates one prompt for each table. Further, the system management platform 110 loops through all data source configurations, and extracts a predetermined number of logs and prompts from each log source. Subsequently, the system management platform 110 inputs the predetermined number of logs and prompts into the machine learning model, to obtain a preliminary learning result output by the machine learning model. Then, the system management platform 110 may further provide the preliminary learning result to the user for confirmation on whether there is a deviation. Further, the system management platform 110 stores a mapping document output by the machine learning model in a predetermined folder. For example, a name of the mapping document may be field_mapping.

In conclusion, embodiments of the present disclosure may reduce the threshold for alarm judgment and tracing, thereby improving the efficiency of alarm processing. For ease of understanding, the method for managing alarms according to the present disclosure is described below with reference to some case analyses. In some embodiments, for abnormal IP login, the system management platform 110 may use the following steps to determine the abnormal IP login.

As an example, the system management platform 110 first receives an alarm for the abnormal IP login. Intrusion link analysis is performed by calling a webshell, and it may be learned that the alarm time is “xx month xx day, xxxx year”. Subsequently, the system management platform 110 analyzes the alarm, and may obtain an analysis report of the alarm. In some examples, the analysis report may include an overall summary of the alarm. The overall summary may include a determination result, a risk score, and a determination basis.

In some embodiments, the analysis report may further include a step-by-step summary. For example, the step-by-step summary may include a step name, an analysis result, a determination result, a risk score, a determination basis, analysis details, and a call time axis that correspond to each step.

In some embodiments, the analysis report may list data sets used. For example, information such as a name and a description of a data set may be shown.

In some embodiments, the analysis report may further include a next processing policy for investigating the alarm. For example, the analysis report may include an ID, a reason, a next suggestion, an entity, and the like that are recommended and that correspond to each step.

In some embodiments, the analysis report may further include further investigation of the alarm. For example, the further investigation includes: a determination result, a risk score, score calculation logic, a determination basis, an attack time axis (for example, including a start time, an end time, an alarm name, an alarm level, and the number of alarms), lateral movement analysis, intrusion process analysis, a summary of the alarm, and listing of data sets used.

In some embodiments, the analysis report may further include a query condition for the data set.

In some embodiments, the system management platform 110 obtains a final tracing analysis report based on automatic judgment on the alarm and tracing of a judgment result. The tracing analysis report includes a judgment result, a risk score, and a judgment basis.

In some embodiments, the tracing analysis report includes a step-by-step summary. The step-by-step summary may include a determination step for each entity related to the alarm, for example, the determination step includes a determination result, alarm importance (or an attack probability), and a determination basis.

In some embodiments, the tracing analysis report may further include evidence for tracing the target alarm. For example, a log name, a determination result, an attack probability, and a determination basis for each piece of log information may be included.

In some embodiments, the tracing analysis report may further include a summary of the tracing alarm.

By providing information in various dimensions in the analysis report, a user such as operation and maintenance personnel may learn the process and logic of analyzing the alarm using the machine learning model. This may help the user determine the accuracy of the analysis result.

In conclusion, in the embodiments of the present disclosure, the analysis result of the alarm is obtained by calling the machine learning model, so that the user may quickly obtain the analysis result of the alarm, to assist the user in making a quick decision. Further, the analysis result and the description information of the alarm may be stored in the alarm information base, to provide a basis for determination of a subsequent similar alarm, thereby improving the efficiency of alarm processing.

### Example Process

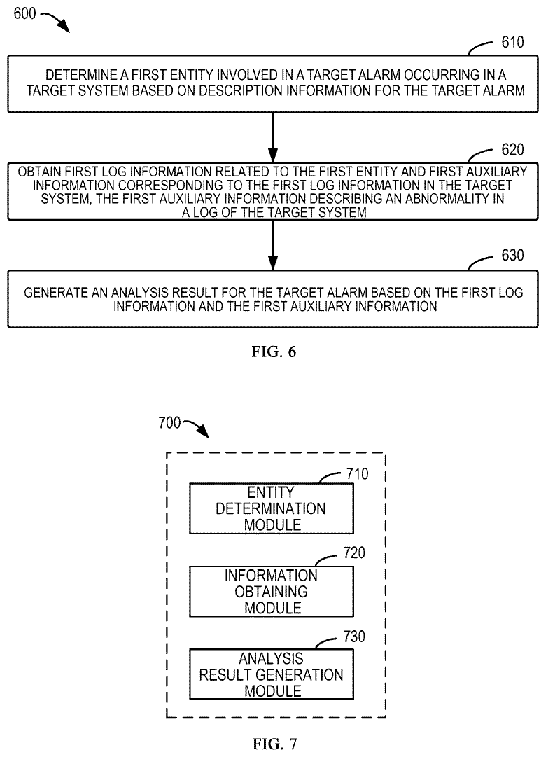

FIG. 6 illustrates a flowchart of a process 600 for alarm processing according to some embodiments of the present disclosure. The process 600 may be implemented at the system management platform 110. The process 600 is described below with reference to FIG. 1.

At block 610, the system management platform 110 determines a first entity involved in a target alarm occurring in a target system based on description information for the target alarm.

At block 620, the system management platform 110 obtains first log information related to the first entity and first auxiliary information corresponding to the first log information in the target system, the first auxiliary information describing an abnormality in a log of the target system.

At block 630, the system management platform 110 generates an analysis result for the target alarm based on the first log information and the first auxiliary information.

In some embodiments, obtaining the first log information and the first auxiliary information includes: determining at least one scenario based on an entity type of the first entity, the scenario in the at least one scenario being configured with a corresponding log range and an abnormal state description within the log range; determining the first log information based on the log range respectively configured in the at least one scenario; and determining the first auxiliary information based on the abnormal state description respectively configured in the at least one scenario.

In some embodiments, determining the at least one scenario based on the entity type of the first entity includes: determining a plurality of candidate scenarios corresponding to the entity type of the first entity; and selecting the at least one scenario from the plurality of candidate scenarios by using a machine learning model and based on the description information of the target alarm.

In some embodiments, determining the first log information includes: extracting, from the target system, a target log fragment as at least a part of the first log information for a first scenario in the at least one scenario based on the log range configured in the first scenario.

In some embodiments, the log range configured in the first scenario indicates a log name and a time range, and extracting the target log fragment includes: determining a target log in the target system based on the log name; determining an extraction range of the target log based on an occurrence time of the target alarm and the time range; and extracting, from the target log, a part within the extraction range as the target log fragment.

In some embodiments, determining the first auxiliary information includes: determining, based on the abnormal state description configured in the first scenario, an auxiliary information item corresponding to the target log fragment to describe an abnormality in the target log fragment.

In some embodiments, the process 600 further includes: performing associated entity detection for the first entity based on the first log information and the first auxiliary information; obtaining, in response to detecting a second entity associated with the first entity, second log information related to the second entity and second auxiliary information corresponding to the second log information in the target system, the second auxiliary information describing an abnormality in the log of the target system; performing associated entity detection for the second entity based on the second log information and the second auxiliary information; and determining an occurrence path of the target alarm based on the first entity and a result of the associated entity detection for the second entity.

In some embodiments, determining the first entity involved in the target alarm includes: obtaining an alarm information base comprising respective description information and respective analysis results of a plurality of historical alarms occurring in the target system; retrieving, in response to receiving the target alarm and based on the description information of the target alarm, a historical alarm matching the target alarm from the alarm information base; and determining, in response to not retrieving a historical alarm matching the target alarm and based on the description information, the first entity by using a machine learning model.

In some embodiments, the process 600 further includes: updating the alarm information base based on the description information of the target alarm and the analysis result for the target alarm.

In some embodiments, the first log information is obtained by using a predetermined log query statement, and the method further includes: determining, before obtaining the first log information, a target log field corresponding to a variable in a log query instruction in a target log of the target system.

In some embodiments, determining the target log field includes: extracting a plurality of log records from the target log; providing prompt information to a machine learning model based on a variable description for the variable and the plurality of log records, to obtain an output of the machine learning model; and determining the target log field based on one or more target fields indicated by the output of the machine learning model.

In some embodiments, the first entity includes at least one of a subject, a file, an object, an account, an address, and a process.

### Example Apparatus and Device

FIG. 7 illustrates a schematic structural block diagram of an apparatus 700 for alarm processing according to some embodiments of the present disclosure. The apparatus 700 may be implemented as or included in the system management platform 110. Each module/component in the apparatus 700 may be implemented by hardware, software, firmware, or any combination thereof.

As shown in the figure, the apparatus 700 includes an entity determination module 710 configured to determine a first entity involved in a target alarm occurring in a target system based on description information for the target alarm. The apparatus 700 further includes an information obtaining module 720 configured to obtain first log information related to the first entity and first auxiliary information corresponding to the first log information in the target system, the first auxiliary information describing an abnormality in a log of the target system. The apparatus 700 further includes an analysis result generation module 730 configured to generate an analysis result for the target alarm based on the first log information and the first auxiliary information.

In some embodiments, the information obtaining module 720 is further configured to determine at least one scenario based on an entity type of the first entity, the scenario in the at least one scenario being configured with a corresponding log range and an abnormal state description within the log range; determine the first log information based on the log range respectively configured in the at least one scenario; and determine the first auxiliary information based on the abnormal state description respectively configured in the at least one scenario.

In some embodiments, the apparatus 700 further includes a scenario determination module configured to a plurality of candidate scenarios corresponding to the entity type of the first entity; and select the at least one scenario from the plurality of candidate scenarios by using a machine learning model and based on the description information of the target alarm.

In some embodiments, the information obtaining module 720 is further configured to: extract, from the target system, a target log fragment as at least a part of the first log information for a first scenario in the at least one scenario based on the log range configured in the first scenario.

In some embodiments, the log range configured in the first scenario indicates a log name and a time range, and the information obtaining module 720 is further configured to determine a target log in the target system based on the log name; determine an extraction range of the target log based on an occurrence time of the target alarm and the time range; and extract, from the target log, a part within the extraction range as the target log fragment.

In some embodiments, the information obtaining module 720 is further configured to determine, based on the abnormal state description configured in the first scenario, an auxiliary information item corresponding to the target log fragment to describe an abnormality in the target log fragment.

In some embodiments, the apparatus 700 further includes an occurrence path determination module configured to perform associated entity detection for the first entity based on the first log information and the first auxiliary information; obtain, in response to detecting a second entity associated with the first entity, second log information related to the second entity and second auxiliary information corresponding to the second log information in the target system, the second auxiliary information describing an abnormality in the log of the target system; perform associated entity detection for the second entity based on the second log information and the second auxiliary information; and determine an occurrence path of the target alarm based on the first entity and a result of the associated entity detection for the second entity.

In some embodiments, the entity determination module 710 is further configured to obtain an alarm information base comprising respective description information and respective analysis results of a plurality of historical alarms occurring in the target system; retrieve, in response to receiving the target alarm and based on the description information of the target alarm, a historical alarm matching the target alarm from the alarm information base; and determine, in response to not retrieving a historical alarm matching the target alarm and based on the description information, the first entity by using a machine learning model.

In some embodiments, the apparatus 700 further includes an alarm information base determination module configured to update the alarm information base based on the description information of the target alarm and the analysis result for the target alarm.

In some embodiments, the first log information is obtained by using a predetermined log query statement, and the apparatus 700 further includes a log field determination module configured to determine, before obtaining the first log information, a target log field corresponding to a variable in a log query instruction in a target log of the target system.

In some embodiments, the log field determination module is further configured to extract a plurality of log records from the target log; provide prompt information to a machine learning model based on a variable description for the variable and the plurality of log records, to obtain an output of the machine learning model; and determine the target log field based on one or more target fields indicated by the output of the machine learning model.

In some embodiments, the first entity includes at least one of a subject, a file, an object, an account, an address, and a process.

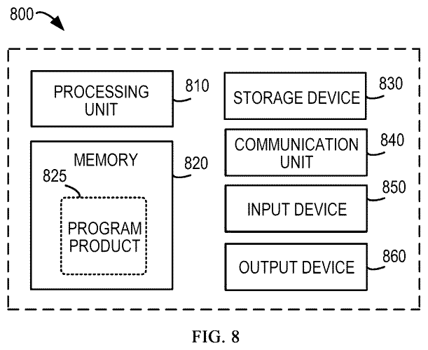

FIG. 8 illustrates a block diagram of an electronic device 800 in which one or more embodiments of the present disclosure may be implemented. It should be understood that the electronic device 800 shown in FIG. 8 is only illustrative, and should not constitute any limitation on the functions and scope of the embodiments described herein. The electronic device 800 shown in FIG. 8 may be configured to implement the electronic device 110 in FIG. 1.

As shown in FIG. 8, the electronic device 800 is in a form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor, and may perform various processing based on a program stored in the memory 820. In a multi-processor system, a plurality of processing units perform computer executable instructions in parallel, to improve the parallel processing capability of the electronic device 800.

The electronic device 800 typically includes a plurality of computer storage medium. Such medium may be any available medium accessible to the electronic device 800, including but not limited to volatile and non-volatile medium, and removable and non-removable medium. The memory 820 may be a volatile memory (for example, a register, a cache, or a random access memory (RAM)), a non-volatile memory (for example, a read-only memory (ROM), an electrically erasable programmable read-only memory (EEPROM), or a flash memory), or any combination thereof. The storage device 830 may be any removable or non-removable medium, may include a machine-readable medium such as a flash drive, a disk, or any other media, and may be used to store information and/or data and accessed in the electronic device 800.

The electronic device 800 may further include other removable/non-removable, volatile/non-volatile memory medium. Although not shown in FIG. 8, a disk driver for reading from or writing into removable and non-volatile disks (for example, a “floppy disk”), and an optical disk driver for reading from or writing into removable and non-volatile optical disks may be provided. In these cases, each driver may be connected to a bus (not shown) through one or more data medium interfaces. The memory 820 may include a computer program product 825 having one or more program modules configured to perform various methods or actions in the embodiments of the present disclosure.

The communication unit 840 implements communication with another electronic device through a communication medium. Additionally, the functions of the components of the electronic device 800 may be implemented by a single computing cluster or a plurality of computing machines, and these computing machines may communicate through a communication connection. Therefore, the electronic device 800 may use a logical connection with one or more other servers, a network personal computer (PC), or another network node to operate in a networked environment.

The input device 850 may be one or more input devices, such as a mouse, a keyboard, a tracking ball, or the like. The output device 860 may be one or more output devices, such as a display, a speaker, a printer, or the like. The electronic device 800 may further communicate with one or more external devices (not shown) such as a storage device and a display device through the communication unit 840 as needed, communicate with one or more devices that enable the user to interact with the electronic device 800, or communicate with any devices (for example, a network card and a modem) that enable the electronic device 800 to communicate with one or more other electronic devices. Such communication may be performed via input/output (I/O) interfaces (not shown).

According to an illustrative implementation of the present disclosure, a computer-readable storage medium is provided, having computer executable instructions stored thereon, where the computer executable instructions are executed by a processor to implement the method described above. According to an illustrative implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and a combination of the blocks in the flowcharts and/or block diagrams may be implemented by computer-readable program instructions.

These computer-readable program instructions may be provided to a processing unit of a general-purpose computer, a dedicated computer, or another programmable data processing apparatus to produce a machine, so that when the instructions are executed by the processing unit of the computer or another programmable data processing apparatus, an apparatus for implementing a specific function/action in one or more blocks in the flowcharts and/or block diagrams is produced. These computer-readable program instructions may also be stored in a computer-readable storage medium, and the instructions cause the computer, the programmable data processing apparatus, and/or another device to work in a specific manner. Therefore, the computer-readable medium storing the instructions includes a manufactured product, which includes instructions for implementing various aspects of the specific function/action in one or more blocks in the flowcharts and/or block diagrams.

The computer-readable program instructions may be loaded onto a computer, another programmable data processing apparatus, or another device, so that a series of operations and steps are performed on the computer, another programmable data processing apparatus, or another device, to generate a computer-implemented process. Therefore, the instructions executed on the computer, another programmable data processing apparatus, or another device implement the specific function/action in one or more blocks in the flowcharts and/or block diagrams.

The flowcharts and block diagrams in the drawings show the possibly implemented architectures, functions, and operations of the systems, the methods, and the computer program products according to a plurality of implementations of the present disclosure. In this regard, each block in the flowcharts or block diagrams may represent a module, a program segment, or a part of an instruction, and the module, the program segment, or the part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a dedicated hardware-based system that performs a specific function or action, or may be implemented by a combination of dedicated hardware and computer instructions.

The implementations of the present disclosure have been described above. The above description is illustrative, not exhaustive, and is not limited to the disclosed implementations. Many modifications and variations are obvious to those of ordinary skill in the art without departing from the scope of the illustrated implementations. The terms used herein are selected to best explain the principles of the implementations, the actual applications, or the improvements to the technologies in the market, or to enable other persons of ordinary skill in the art to understand the implementations disclosed herein.

1. A method for alarm processing, comprising:
determining a first entity involved in a first alarm occurring in a first system based on description information for the first alarm;
obtaining first log information related to the first entity and first auxiliary information corresponding to the first log information in the first system, the first auxiliary information describing an abnormality in a log of the first system; and
generating an analysis result for the first alarm based on the first log information and the first auxiliary information.

2. The method of claim 1, wherein obtaining the first log information and the first auxiliary information comprises:
determining at least one scenario based on an entity type of the first entity, the scenario in the at least one scenario being configured with a corresponding log range and an abnormal state description within the log range;
determining the first log information based on the log range respectively configured in the at least one scenario; and
determining the first auxiliary information based on the abnormal state description respectively configured in the at least one scenario.

3. The method of claim 2, wherein determining at least one scenario based on the entity type of the first entity comprises:
determining a plurality of candidate scenarios corresponding to the entity type of the first entity; and
selecting the at least one scenario from the plurality of candidate scenarios by using a machine learning model and based on the description information of the first alarm.

4. The method of claim 2, wherein determining the first log information comprises:
extracting, from the first system, a first log fragment as at least a part of the first log information for a first scenario in the at least one scenario based on the log range configured in the first scenario.

5. The method of claim 4, wherein the log range configured in the first scenario indicates a log name and a time range, and extracting the first log fragment comprises:
determining a first log in the first system based on the log name;
determining an extraction range of the first log based on an occurrence time of the first alarm and the time range; and
extracting, from the first log, a part within the extraction range as the first log fragment.

6. The method of claim 4, wherein determining the first auxiliary information comprises:
determining, based on the abnormal state description configured in the first scenario, an auxiliary information item corresponding to the first log fragment to describe an abnormality in the first log fragment.

7. The method of claim 1, further comprising:
performing associated entity detection for the first entity based on the first log information and the first auxiliary information;
obtaining, in response to detecting a second entity associated with the first entity, second log information related to the second entity and second auxiliary information corresponding to the second log information in the first system, the second auxiliary information describing an abnormality in the log of the first system;
performing associated entity detection for the second entity based on the second log information and the second auxiliary information; and
determining an occurrence path of the first alarm based on the first entity and a result of the associated entity detection for the second entity.

8. The method of claim 1, wherein determining the first entity involved in the first alarm comprises:
obtaining an alarm information base comprising respective description information and respective analysis results of a plurality of historical alarms occurring in the first system;
retrieving, in response to receiving the first alarm and based on the description information of the first alarm, a historical alarm matching the first alarm from the alarm information base; and
determining, in response to not retrieving a historical alarm matching the first alarm and based on the description information, the first entity by using a machine learning model.

9. The method of claim 8, further comprising:
updating the alarm information base based on the description information of the first alarm and the analysis result for the first alarm.

10. The method of claim 1, wherein the first log information is obtained by using a predetermined log query statement, and the method further comprises:
determining, before obtaining the first log information, a first log field corresponding to a variable in a log query instruction in a first log of the first system.

11. The method of claim 10, wherein determining the first log field comprises:
extracting a plurality of log records from the first log;
providing prompt information to a machine learning model based on a variable description for the variable and the plurality of log records, to obtain an output of the machine learning model; and
determining the first log field based on one or more first fields indicated by the output of the machine learning model.

12. The method of claim 1, wherein the first entity comprises at least one of a subject, a file, an object, an account, an address, and a process.

13. An electronic device, comprising:
at least one processor; and
at least one memory, wherein the at least one memory is coupled to the at least one processor, and stores instructions executable by the at least one processor, the instructions, when executed by the at least one processor, causing the electronic device to perform acts comprising:
determining a first entity involved in a first alarm occurring in a first system based on description information for the first alarm;
obtaining first log information related to the first entity and first auxiliary information corresponding to the first log information in the first system, the first auxiliary information describing an abnormality in a log of the first system; and
generating an analysis result for the first alarm based on the first log information and the first auxiliary information.

14. The electronic device of claim 13, wherein obtaining the first log information and the first auxiliary information comprises:
determining at least one scenario based on an entity type of the first entity, the scenario in the at least one scenario being configured with a corresponding log range and an abnormal state description within the log range;
determining the first log information based on the log range respectively configured in the at least one scenario; and
determining the first auxiliary information based on the abnormal state description respectively configured in the at least one scenario.

15. The electronic device of claim 14, wherein determining at least one scenario based on the entity type of the first entity comprises:
determining a plurality of candidate scenarios corresponding to the entity type of the first entity; and
selecting the at least one scenario from the plurality of candidate scenarios by using a machine learning model and based on the description information of the first alarm.

16. The electronic device of claim 14, wherein determining the first log information comprises:
extracting, from the first system, a first log fragment as at least a part of the first log information for a first scenario in the at least one scenario based on the log range configured in the first scenario.

17. The electronic device of claim 16, wherein the log range configured in the first scenario indicates a log name and a time range, and extracting the first log fragment comprises:
determining a first log in the first system based on the log name;
determining an extraction range of the first log based on an occurrence time of the first alarm and the time range; and
extracting, from the first log, a part within the extraction range as the first log fragment.

18. The electronic device of claim 16, wherein determining the first auxiliary information comprises:
determining, based on the abnormal state description configured in the first scenario, an auxiliary information item corresponding to the first log fragment to describe an abnormality in the first log fragment.

19. The electronic device of claim 13, wherein the acts further comprise:
performing associated entity detection for the first entity based on the first log information and the first auxiliary information;
obtaining, in response to detecting a second entity associated with the first entity, second log information related to the second entity and second auxiliary information corresponding to the second log information in the first system, the second auxiliary information describing an abnormality in the log of the first system;
performing associated entity detection for the second entity based on the second log information and the second auxiliary information; and
determining an occurrence path of the first alarm based on the first entity and a result of the associated entity detection for the second entity.

20. A non-transitory computer-readable storage medium having a computer program stored thereon, wherein the computer program is executable by a processor to implement acts comprising:
determining a first entity involved in a first alarm occurring in a first system based on description information for the first alarm;
obtaining first log information related to the first entity and first auxiliary information corresponding to the first log information in the first system, the first auxiliary information describing an abnormality in a log of the first system; and
generating an analysis result for the first alarm based on the first log information and the first auxiliary information.
